(19) United States
(12) Patent Application Publication
(10) Pub. No.: US 2022/0083930 A1
(43) Pub. Date: Mar. 17, 2022

(54) LOG VISUALIZATION DEVICE, LOG VISUALIZATION METHOD, AND LOG VISUALIZATION PROGRAM

(71) Applicant: Nippon Telegraph and Telephone Corporation, Tokyo (JP)

(72) Inventors: Yuki Urabe, Musashino-shi, Tokyo (JP); Kimio Tsuchikawa, Musashino-shi, Tokyo (JP); Sayaka Yagi, Musashino-shi, Tokyo (JP); Takeshi Masuda, Musashino-shi, Tokyo (JP)

(21) Appl. No.: 17/422,860

(22) PCT Filed: Jan. 15, 2020
(86) PCT No.: PCT/JP2020/001041

§ 371 Date: Jul. 14, 2021

(30) Foreign Application Priority Data
Jan. 29, 2019 (JP) 2019-013257

(51) Int. Cl. G06Q 10/06

(52) U.S. Cl. CPC G06Q 10/0633; G06Q 10/067; G06Q 10/06375

(57) ABSTRACT

A storage unit (14) stores a plurality of pieces of log data. A flow generation unit (15b) generates a flow in which the pieces of log data are arranged in a processing order. A labeling unit (15c) provides a label, set by a user, to log data in a range designated by the user in the flow. When the same label is provided to a plurality of pieces of log data, a flow update unit (15d) updates the flow to display the plurality of pieces of log data as a single piece of log data.

### TECHNICAL FIELD

The present invention relates to a log visualization device, a log visualization method, and a log visualization program.

### BACKGROUND ART

In general, business process analysis for improving business processes of companies has been performed with a business process analyst performing a procedure including, in this order: recognizing the actual condition of a target business process; finding a problem; drafting an improvement plan; applying the plan to the actual business process; and checking the effect (see Non Patent Literatures 1 and 2).

An analog analytical technique (such as an interview with a worker and measuring time using a stopwatch) applied for checking the actual condition of a business process leads to problems such as data with insufficient coverage or objectiveness, as well as an extra work required. In view of this, analytical techniques using an operational log recorded when a user operates a terminal have been proposed (see Patent Literature 1 and Non Patent Literature 3). Furthermore, analytical techniques using system logs recorded when a user operates a terminal or log data generated by an application have been proposed (see Non Patent Literature 4).

A business process analyst needs to accurately recognize a business process with a granularity suitable for analysis purposes, in order to find the problem with the business process For example, if the purpose of the analysis is to shorten the lead time from receipt of request for a service to provision of the service, the business process analyst first needs to clearly figure out the types and the order of business processes performed between the receipt of request for the service to the provision of the service. Then, the business process analyst identifies factors hindering the business processes, such as work taking a long period of time and work that is likely to involve reworking. In this manner, the problems are preferably found with the actual condition of the business process recognized while changing the granularity of business processes to be recognized in accordance with the purpose of analysis.

Note that techniques for visualizing a system log or an operational log in a form of a flow have been disclosed (Patent Literature 2 and Non Patent Literature 5). Furthermore, a technique for searching a matching part between two character strings has been known (see Non Patent Literature 6).

### CITATION LIST

### Patent Literature

Patent Literature 1: JP 2015-153210 A

Patent Literature 2: JP 2015-079305 A

### Non Patent Literature

Non Patent Literature 1: “ERP basic knowledge—What exactly is business process improvement? Description on purpose and procedure”, [online], freee K.K, [Searches on Dec. 25, 2018], Internet: <URL: https://www.freee.co.jp/kb/kb-erp/operational-efficiency/>

Non Patent Literature 2: “Improving Business Processes: Streamlining Tasks to Improve Efficiency”, [online], MindTools, [searched on Dec, 25, 2018], Internet <URL: https://www.mindtools.com/pages/article/improving-business-processes.htm>

Non Patent Literature 3: “System Log”, [online], 2013, IT term dictionary, [Searched on Dec. 25, 2018], Internet: http://e-words.jp/w [symbol] .html>

Non Patent Literature 4: “Business process visualization and analysis system (BPOST)”, [online], 2008 years, NTT Access Service System Laboratories, [Searched on Dec. 25, 2018], Internet <URL: http://www.ansl.ntt.co.jp/history/process/ne0005.html>

Non Patent Literature 5: “Graphviz-Graph Visualization Software”, [online], [searched on Dec. 25, 2018], Internet <URL: http://www.graphviz.org/>

Non Patent Literature 6: R. Boyer, J. Moore, “A Fast String Searching Algorithm”, Communication of the ACM, 1977, Vol. 20, No. 10, pp. 762 to 772

### SUMMARY OF THE INVENTION

### Technical Problem

Unfortunately, with the related art, system logs and operational logs might be difficult to visualize in a form of a business process flow with an appropriate granularity. For example, direct visualization of system logs and operational logs in a form of a flow does not enable a business process analyst to figure out how operations and business processes flow, unless he or she is aware of the association between work and the business process corresponding to information on each system log and operational log. Thus, the business process analyst checks the contents of the logs, and manually adjusts the logs to achieve a flow with a desired granularity, and then implements the visualization. Alternatively, the log is automatically adjusted and visualized (see Non Patent Literature 4) based on a set of contents setout in advance by the business process analyst from various perspectives. In any of these cases, the log adjustment processing and the visualization processing are independently executed, meaning that the log needs to be adjusted in advance based on an anticipated visualization result.

It is difficult for the business process analyst to recognize what kinds of operations are performed, before the logs are visualized. It is also difficult to adjust the log in advance based on an anticipated visualization result for all of the operations. Thus, in practice, the business process analyst first needs to adjust the logs based on his or her experience and intuition and check the visualization result to find what needs to be fixed, and then repeat the log adjustment. Furthermore, when the perspective of the business process analysis changes, such repetitive operations need to be performed again. All things considered, it has been difficult to continuously analyze business processes.

The present invention has been made in view of the above, and an object of the present invention is to visualize a system log and an operational log into a business process flow with an appropriate granularity.

### Means for Solving the Problem

A log visualization device according to the present invention for solving the problem described above and achieve the object includes: a storage unit configured to store a plurality of pieces of log data; a flow generation unit configured to generate a flow in which the pieces of log data are arranged in a processing order; a labeling unit configured to provide a label set by a user to log data, in the flow, within a range designated by the user; and a flow update unit configured to update, when same label is provided to a plurality of pieces of log data, the flow to display the plurality of pieces of log data as a single piece of log data.

### Effects of the Invention

With the present invention, system logs and operational logs can be visualized as a business process flow with an appropriate granularity.

### BRIEF DESCRIPTION OF DRAWINGS

FIG. 1 is a schematic diagram illustrating an overall configuration of a log visualization device according to the present embodiment;

FIG. 2 is a diagram illustrating a data configuration of log data;

FIG. 3 is a diagram for explaining processing executed by a flow generation unit;

FIG. 4 is a diagram illustrating an overview of processing executed by a labeling unit and a flow update unit;

FIG. 5 is a table illustrating processing executed by the labeling unit;

FIG. 6A is a diagram illustrating an overview of processing executed by the labeling unit and the flow update unit;

FIG. 6B is a diagram illustrating an overview of processing executed by the labeling unit and the flow update unit;

FIG. 7 is a diagram illustrating processing executed by the labeling unit and the flow update unit;

FIG. 8A is a diagram illustrating an overview of processing executed by the labeling unit and the flow update unit;

FIG. 8B is a diagram illustrating an overview of processing executed by the labeling unit and the flow update unit;

FIG. 9A is a diagram illustrating an overview of processing executed by the labeling unit and the flow update unit;

FIG. 9B is a diagram illustrating an overview of processing executed by the labeling unit and the flow update unit;

FIG. 9C is a diagram illustrating an overview of processing executed by the labeling unit and the flow update unit;

FIG. 10 is a flowchart illustrating a log visualization processing procedure; and

FIG. 11 is a diagram illustrating an example of a computer that executes a log visualization program.

### DESCRIPTION OF EMBODIMENTS

Hereinafter, an embodiment of the present invention will be described in detail with reference to the drawings. Note that the present invention is not limited by the embodiment. Further, in description of the drawings, the same parts are denoted by the same reference signs.

Configuration of Log Visualization Device

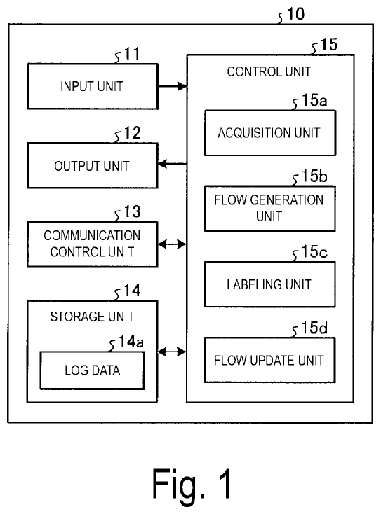

FIG. 1 is a schematic diagram illustrating an overall configuration of a log visualization device according to the present embodiment. As illustrated in FIG. 1, this log visualization device 10 is realized by a general-purpose computer such as a personal computer and includes an input unit 11, an output unit 12, a communication control unit 13, a storage unit 14, and a control unit 15.

The input unit 11 is realized by using an input device such as a keyboard, a mouse, or a touch panel, and inputs various kinds of instruction information for starting processing to the control unit 15 or the like in response to an operation input by a user. In log visualization processing described later, the control unit 15 according to the present embodiment receives, via the input unit 11, inputs from the user for example, for purposes such as designating the range of a flow and setting a label.

The output unit 12 is realized by a display apparatus such as a liquid crystal display or a printing apparatus such as a printer. In the log visualization processing described later, the control unit 15 according to the present embodiment displays, for example, a visualized flow generated, an updated flow, or the like, to the user via the output unit 12.

The communication control unit 13 is realized by a network interface card (NIC), or the like, and controls communication between the control unit 15 and an external apparatus via an electric communication line such as a local area network (LAN) or the Internet. For example, the communication control unit 13 controls communications between the control unit 15 and an external device such as a user terminal and a management device that manages log data used for the log visualization processing described later.

The storage unit 14 is realized by a storage device such as a semiconductor memory element like a random access memory (RAM) or a flash memory, a hard disk, an optical disc, or the like. In the present embodiment, the storage unit 14 stores log data 14a. Note that the storage unit 14 may be configured to communicate with the control unit 15 via the communication control unit 13.

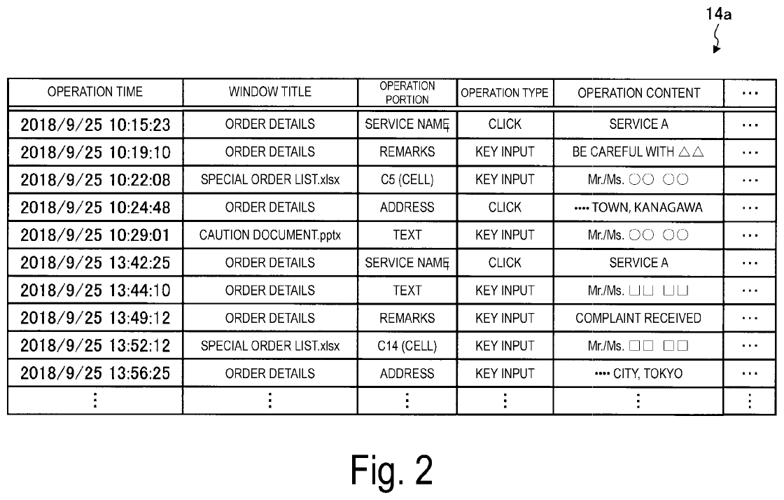

FIG. 2 illustrates an example of log data 14a. The log data 14a includes processing time and processing content. Specifically, as illustrated in FIG. 2, the log data 14a is, for example, an operational log recorded when the user operates a terminal, and includes operation time, window title, operation portion, operation type, operation content, and the like.

The operation time is the processing time for the operational log. The operation content is the processing content for the operational log. The window title is a title of the window that is an operation target. The operation portion is information indicating an operation target portion in the window. The operation type is information indicating the type of operation such as clicking or key input.

FIG. 2 illustrates an example where an operation of an operation type “clicking” is performed on an operation content “service A” in an operation portion “service name”, within a window of a title “order detail”, at operation time “10:15:23, 9/25, 2018”, for example.

Note that the log data 14a is not limited to the operational log illustrated in FIG. 2, and may be, for example, a system log recorded when the user operates the terminal or log data generated by application. In the present embodiment, the log data 14a is acquired from a user terminal, a management device, or the like and stored in the storage unit 14, before the log visualization processing described later is executed.

The control unit 15 is realized by using a central processing unit (CPU), and executes a processing program stored in a memory. Thus, the control unit 15 functions as an acquisition unit 15a, a flow generation unit 15b, a labeling unit 15c, and a flow update unit 15d, as illustrated in FIG. 1. Note that the configuration of the functional units is not limited to this. For example, the flow generation unit 15b and the flow update unit 15d may be configured as one functional unit. The control unit 15 may further include other functional units. Note that the above-described functional units may be implemented respectively, or a part of the functional units may be implemented in different hardware.

The acquisition unit 15a acquires the log data 14a via the input unit 11 or the communication control unit 13 and stores the log data 14a in the storage unit 14, before the log visualization processing described later is executed.

The flow generation unit 15b generates a flow in which the pieces of log data 14a are arranged in a processing order. Specifically, the flow generation unit 15b processes the pieces of log data 14a, so that the pieces of log data 14a are arranged in the processing order and are visualized as a flow to be displayable on the output unit 12. Here, arranging in the processing order meant that records (hereinafter, also referred to as logs) of the log data 14a are arranged in chronological order. Furthermore, when the log data 14a is acquired for each series of processes identified using identification information such as an order ID, arranging in the processing order, for example, also means that logs are arranged in chronological order for such each series of processes. For example, in a case where a plurality of pieces of log data 14a corresponding to different order IDs are acquired, the flow generation unit 15b generates a flow branched for each order ID.

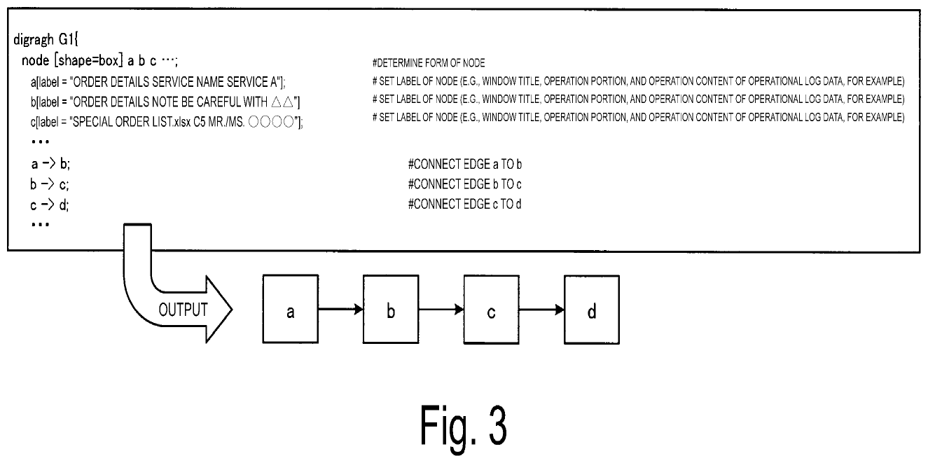

FIG. 3 is a diagram for explaining processing executed by the flow generation unit 15b. As illustrated in FIG. 3, the flow generation unit 15b generates a flow from the log data 14a using, for example, Graphviz (see Non Patent Literature 5). For example, the flow generation unit 15b determines a form for visualizing each node that is each log in the log data 14a, sets a label displayed for each node, and sets an edge establishing connection between nodes. In the example illustrated in FIG. 3, the flow generation unit 15b makes boxes a, b, c, d, . . . each representing a node, makes a list of values of “window title”, “operation portion”, and “operation content” for each log as a label of each node, and makes connection of the edges in the directions from a to b, b to c, c to d, and so on.

Furthermore, the flow generation unit 15b adds “start” and “end” nodes respectively at the beginning and the end of a series of processes, for the log data 14a corresponding to each series of processes identified with identification information such as an order ID. In this manner, the flow generation unit 15b generates a branched flow.

The labeling unit 15c provides a label set by the user to log data in a range in the flow designated by the user. When the same label is provided to a plurality of pieces of log data, the flow update unit 15d updates the flow to display the plurality of pieces of log data as a single piece of log data.

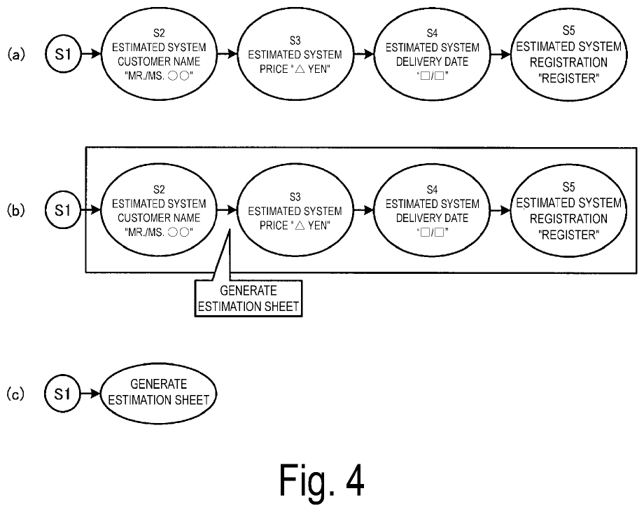

FIG. 4 is a diagram illustrating an overview of processing executed by the labeling unit 15c and the flow update unit 15d. First of all, as illustrated in FIG. 4(a), the flow generated by the flow generation unit 15b is visualized and displayed on the output unit 12. As illustrated in FIG. 4(b), the user uses the input unit 11 to designate, on the displayed flow, a range of nodes and set a label for the nodes in the range. In the example illustrated in FIG. 4(b), the user designates a range of nodes S2 to S5 and sets a label “generate estimation sheet” provided to the nodes S2 to S5 in the range.

In this case, the labeling unit 15c provides the label “generate estimation sheet” to logs corresponding to the nodes S2 to S5 in the designated range. Then, as illustrated in FIG. 4(c), the flow update unit 15d updates the flow to make the plurality of logs provided with the same label “generate estimation sheet” displayed as a single node. In the example illustrated in FIG. 4(c), the nodes are displayed as one node “generate estimation sheet”.

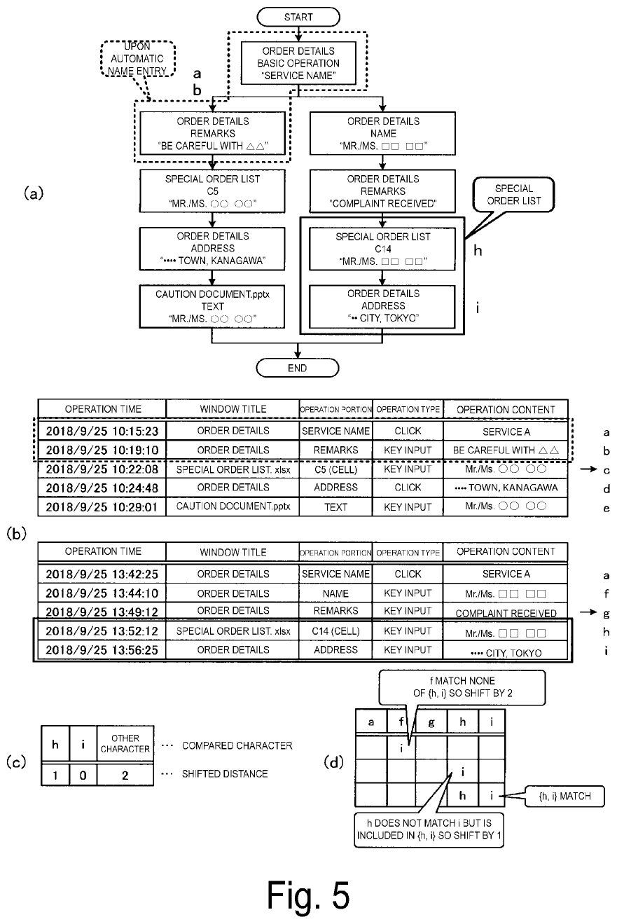

FIG. 5 is a diagram illustrating processing executed by the labeling unit 15c. The labeling unit 15c uses a BM method (see Non Patent Literature 6), for example, to designate log data corresponding to nodes in the range designated by the user.

Specifically, the labeling unit 15c first replaces a log in each row of log data 14a with any appropriate character, as illustrated in FIG. 5(b). In the example illustrated in FIG. 5(b), logs in first, second, . . . , and fifth rows in first one of two series of log data 14a with different order IDs are respectively replaced with “a”, “b”, . . . , and “e”. Logs in the first, . . . , fourth, and fifth rows of the second series are respectively replaced with “a”, . . . , “h”, and “i”. Thus, the log data 14a is replaced with two character strings {a, b, c, d, e} and {a, f, g, h, i}.

Note that logs that can be regarded as being the same are replaced with the same character. For example, in the example illustrated in FIG. 5(b), logs with the same values of “window title”, “operation portion”, “operation type”, and “operation content” matching are regarded as being the same log, and thus are replaced with the same character.

Furthermore, as illustrated in FIG. 5(a), the labeling unit 15c replaces each node in the range designated by the user with a character, as in the case with each log of the log data 14a. Also in this case, the nodes that can be regarded as being the same as the log are replaced with the same character. For example, in the example illustrated in FIG. 5(a), nodes, on a flow, with the values of “window title”, “operation portion”, and “operation content” displayed as their labels, matching are regarded as the same log, and are replaced with the same character. As a result, nodes in a range indicated by the dotted line in FIG. 5(a) are replaced with a character string {a, b}. Nodes in a range indicated by the bold line in FIG. 5(a) are replaced with a character string {h, i}.

Note that, in the processing described above, the logs or nodes replaced with the same character by the labeling unit 15c is not limited to those with the values of “window title”, “operation portion”, “operation type”, and “operation content” matching. For example, the labeling unit 15c may regard logs with values of “window title” and “operation portion” matching as the same log, and replace them with the same character. Thus, for example, address inputting operations may be regarded as the same node, regardless of whether the specific “operation content” differs among them.

Next, the labeling unit 15c searches the character strings {a, b, c, d, e} and {a, f, g, h, i}, representing the log data 14a, for parts matching the character strings {a, b} and {h, i} indicating nodes in the range designated on the flow. In this process, the labeling unit 15c searches for a matching part therebetween, using a shift table according to the BM method.

For example, to find a part matching {h, i} in {a, f, g, h, i}, the labeling unit 15c compares the last character “i” in the search target character string {h, i}, with {a, f, g, h, i}, as illustrated in FIG. 5(d). First or all, the labeling unit 15c compares “i” in {h, i} with the second one “f” of the characters in {a, f, g, h, i}. In this case, the labeling unit 15c refers to a shift table illustrated in FIG. 5(c) to find that the “f” does not match “h” or “i”, and thus shifts {h, i} by two.

Thus, the labeling unit 15c compares “i” in {h, i} with “h” in {a, f, g, h, i}. In this case, the labeling unit 15c refers to the shift table to find that “i” does not match but “h” matches, and thus shifts {h, i} by 1. Then, the labeling unit 15c compares “i” in {h, i} with “i” in {a, f, g, h, i}. In this case, “i” in {h, i} matches “i” in {a, f, g, h, i}. In this manner, the labeling unit 15c detects a part in {a, f, g, h, i} matching {h, i}.

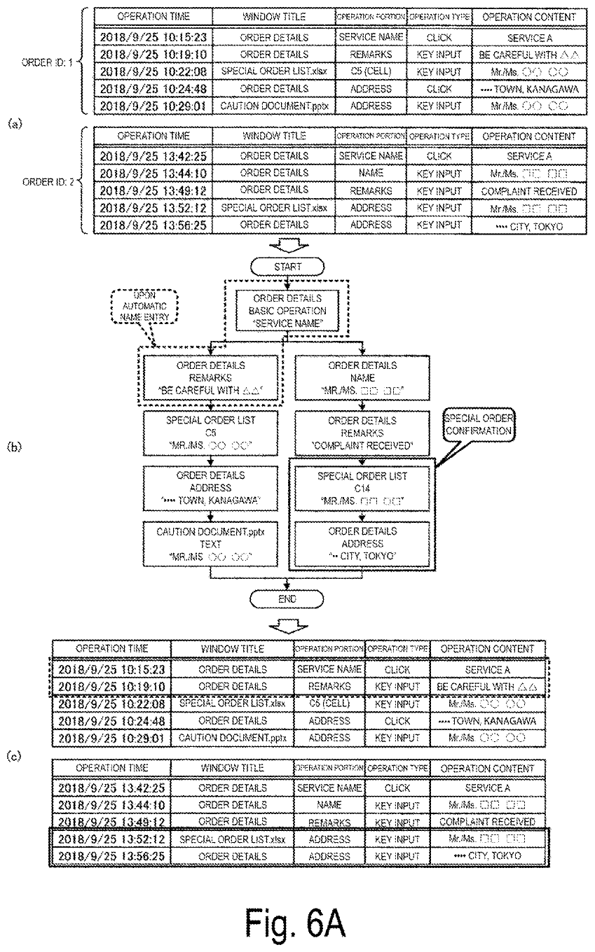

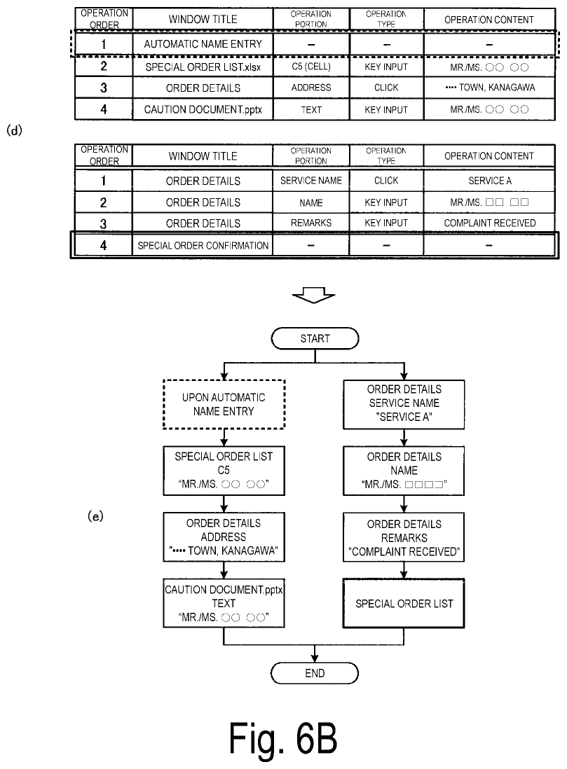

FIGS. 6A and 6B are diagrams illustrating processing executed by the labeling unit 15c and the flow update unit 15d. The labeling unit 15c identifies a log corresponding to a node in the range designated by the user on the flow, as illustrated in FIG. 6A. FIGS. 6A and 6B illustrate an example of processing on log data 14a of two series including log data 14a with an order ID 1 and log data 14a with an order ID 2, as illustrated in FIG. 6A(a).

In this case, the flow generation unit 15b generates a flow branched for each order ID, as illustrated in FIG. 6A(b). The user then designates a range of nodes on the flow that is being displayed, and sets the label to be provided. In the example illustrated in FIG. 6A(b), the label “upon automatic name entry” is set to be provided to nodes in a range indicated by the dotted line, and a label “special order confirmation” is set to be provided to nodes in a range indicated by the bold line.

As illustrated in FIG. 6A(c), the labeling unit 15c identifies logs corresponding to nodes in the range designated by the user in FIG. 6A(b). Then, as illustrated in FIG. 6B(d), the labeling unit 15c provides a label set by the user to the logs thus identified. In the example illustrated in FIG. 6B(d), the labeling unit 15c groups the logs identified into a single node, and collectively provides them with a label set to “window title”. Note that in the example illustrated in FIG. 6B(d), a plurality of logs that are grouped into a single node are masked.

Thus, as illustrated in FIG. 6B(e), the flow update unit 15d can update the flow to display the nodes, in the range designated by the user in FIG. 6A(b), grouped into a single node and provided with the set label. In the example illustrated in FIG. 6B(e), nodes in a range indicated by the dotted line in FIG. 6A(b) are displayed as a single node with the label “upon automatic name entry”, and nodes in a range indicated by the bold line are displayed as a single node with the label “special order confirmation”.

Note that in the example illustrated in FIG. 6B(d), a plurality of logs that are grouped into a single node and masked can be separated from one another again. Accordingly, in a case where the label is further set by the user, the flow update unit 15d can update the flow to display a plurality of pieces of log data that have been displayed as a single piece of log data with the label provided in the updated flow, as a plurality of separate pieces of log data.

Specifically, the flow update unit 15d can update the flow so as to convert the flow illustrated in FIG. 6B(e) to restore the flow illustrated in FIG. 6A(b). This enables the user to easily check the flow with the granularity of the business process easily changed.

When the same label is provided to pieces of log data in a plurality of designated ranges, the flow update unit 15d may update the flow so that the pieces of log data in a plurality of designated ranges are displayed as a flow branched for each of the ranges. Thus, when the same label is set to nodes in different ranges, the flow update unit 15d may update the flow to be displayed as a flow branched for each range.

For example, when a user instructs the same labels provided to different ranges to be displayed while being distinguished from each other, the labeling unit 15c may add identification information for identifying the ranges to the label set by the user. In this case, the flow update unit 15d adds a “start” node and an “end node” respectively at the beginning and the end of a series of processing for each range. Then, the flow update unit 15d generates a branched flow.

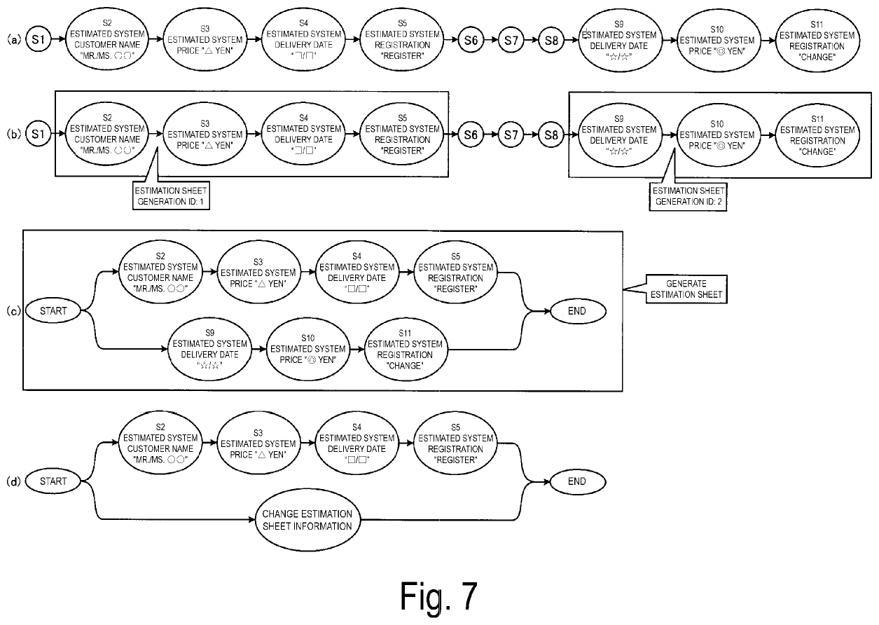

FIG. 7 is a diagram illustrating processing executed by the labeling unit 15c and the flow update unit 15d. FIG. 7 illustrates an example of processing executed when the same label is provided to pieces of log data in different ranges. In the example illustrated in FIG. 7, the user designates the label “generate estimation sheet” to be provided to two ranges in the flow generated by the flow generation unit 15b as illustrated in FIG. 7(a). The ranges include a range including nodes S2 to S5 and a range including nodes S9 to S11 as illustrated in FIG. 7(b). In this case, the labeling unit 15c provides an ID: 1 to the label for the range including the nodes S2 to S5, and provides an ID: 2 to the label for the range including the nodes S9 to S11.

Then, as illustrated in FIG. 7(c), the flow update unit 15d may update the flow with the label “generate estimation sheet” as a flow branched into flows for the nodes S2 to S5 and for the nodes S9 to S11 with different IDs provided. In this case, the flow update unit 15d adds a “start” node and an “end” node respectively at the beginning and the end of the flow with the label “generate estimation sheet”.

The flow update unit 15d can also update the flow so that the flow is displayed together with the labels set for the ranges designated by the user on the flow. FIG. 7(d) illustrates an example of the flow updated by the flow update unit 15d in the case where the range of the nodes S9 to S11 is designated to be provided with a label “change estimation sheet information” in FIG. 7(c).

Note that the labeling unit 15c and the flow update unit 15d may accept a plurality of labels are designated, and then update and output the flow. Alternatively, the labeling unit 15c and the flow update unit 15d may update and output the flow each time a label is set.

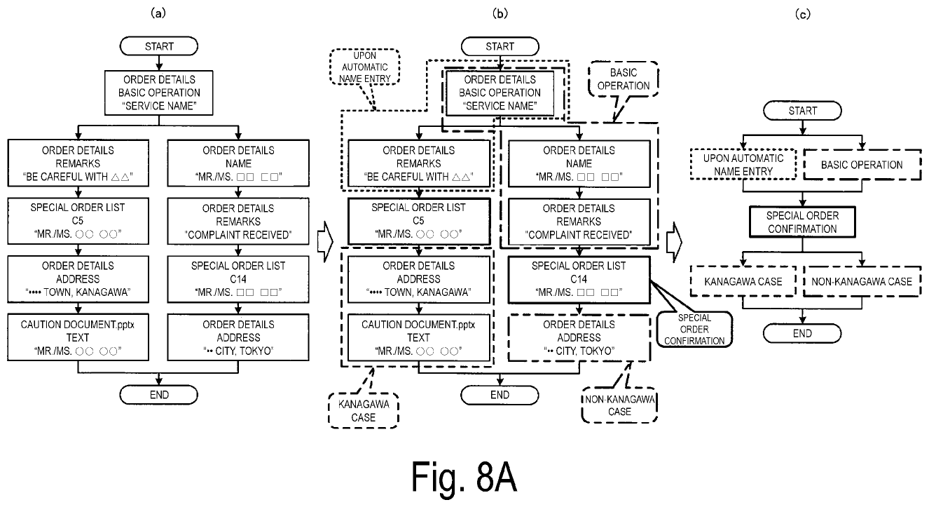

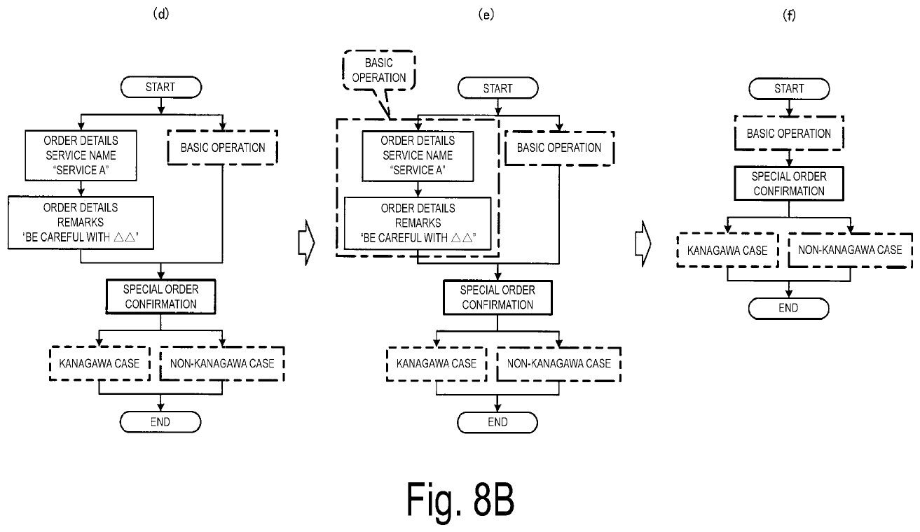

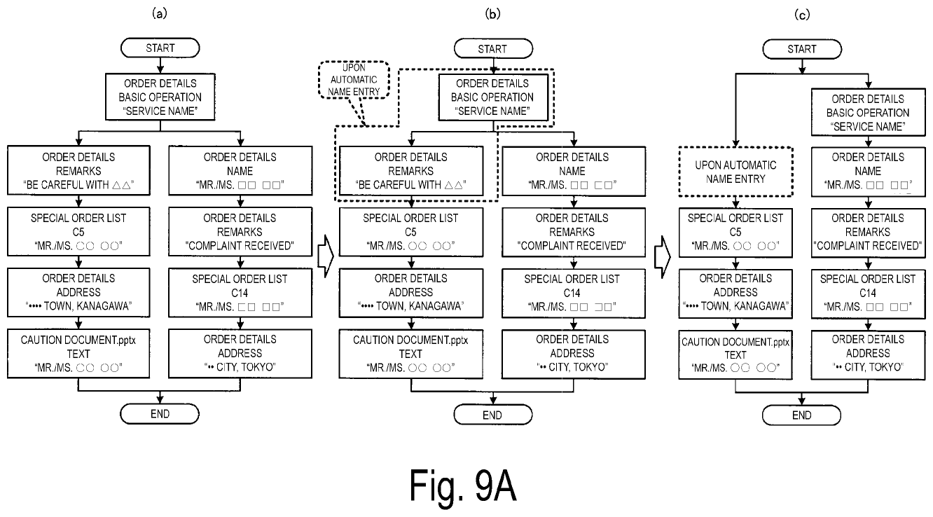

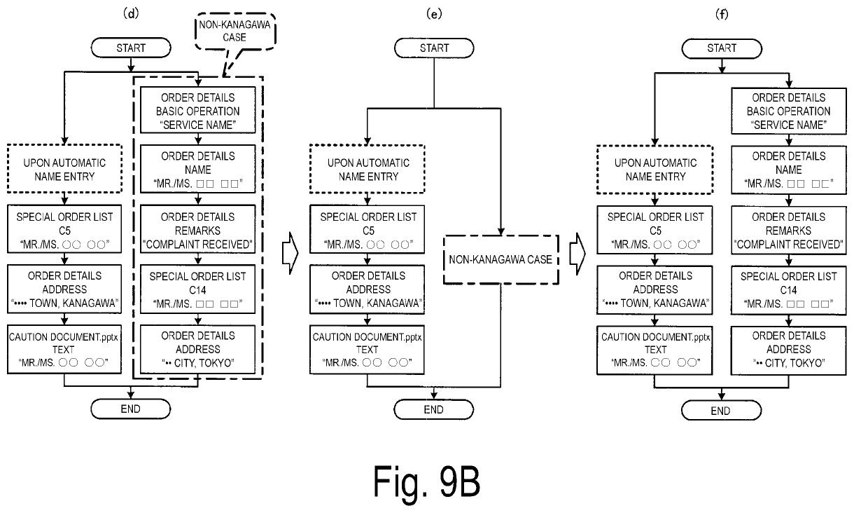

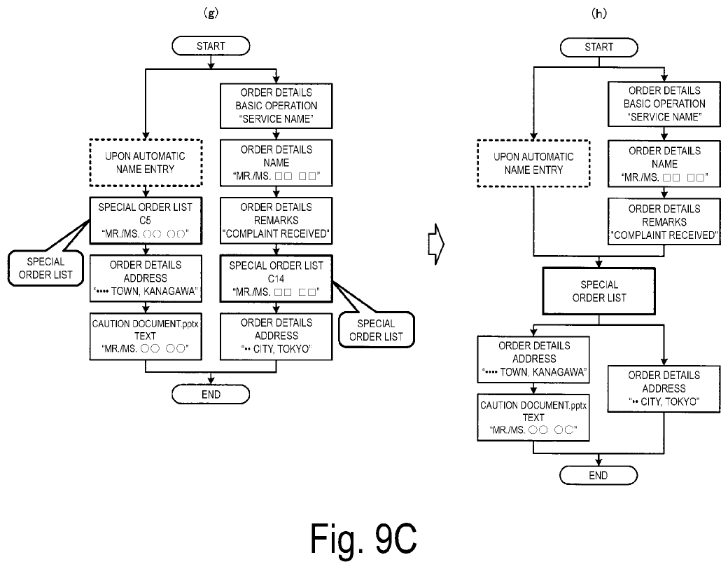

FIGS. 8A to 9C are diagrams illustrating processing executed by the labeling unit 15c and the flow update unit 15d. FIGS. 8A and 8B illustrate an example where a flow is updated and output after a certain plurality of labels have been set. FIGS. 9A to 9C illustrate an example where the flow is updated and output each time a label is set.

First of all, FIG. 8A(a) illustrates an example where a flow branched for each different order ID is displayed. As illustrated in FIG. 8A(b), the user designates a range of a plurality of nodes on the displayed flow and sets a label to be provided to each of the nodes. In the example illustrated in FIG. 8A(b), the label “upon automatic name entry” is set to be provided to nodes in a range indicated by the dotted line, and a label “special order confirmation” is set to be provided to nodes in a range indicated by the bold line. Furthermore, a label “basic operation” is set to be provided to nodes in a range indicated by the dot-dashed line, a label “Kanagawa case” is set to be provided to nodes in a range indicated by the dashed line, and a label “non-Kanagawa case” is designated to be provided to nodes in a range indicated by the two-dot-dashed line.

In this case, the labeling unit 15c accepts designation of these plurality of labels, and then provides the plurality of labels to the logs of the log data 14a. The flow update unit 15d updates the flow using the logs provided with the labels by the labeling unit 15c, so that logs provided with the same label displayed are displayed as a single log as illustrated in FIG. 8A(c).

Furthermore, as illustrated in FIG. 8B(d), when a user designates a label, the flow update unit 15d can update the flow so that a plurality of logs that have been provided with the set label and displayed as a single log, can be displayed separately again. FIG. 8B(d) illustrates an example where the user has set the label “upon automatic name entry”.

As illustrated in FIG. 8B(e), the labeling unit 15c can again accept the designation of a range on the flow and setting of the label to be provided from the user. FIG. 8B(e) illustrates an example where a label “basic operation” is set to be provided to nodes in a range indicated by the dot-dashed line. In this case, as illustrated in FIG. 8B(f), the flow update unit 15d updates the flow so that logs provided with the same label “basic operation” are displayed as a single log.

FIG. 9A(a) illustrates an example where a flow branched for each different order ID is displayed, as in FIG. 8A. As illustrated in FIG. 9A(b), the user determines one range of nodes on the displayed flow and designates a label to be provided. FIG. 9A(b) illustrates an example where a label “upon automatic name entry” is set to be provided to nodes in a range indicated by the dotted line. In this case, the labeling unit 15c provides the designated label “upon automatic name entry” to logs of the log data 14a that correspond to the designated range. Furthermore, as illustrated in FIG. 9A(c), the flow update unit 15d updates the flow so that logs provided with the designated label “upon automatic name entry” are displayed as a single log.

FIG. 9B(d) illustrates an example where a user sets a range indicated by a dot-dashed line, different from the above, and designates the label “non-Kanagawa case” to be provided. In this case, the labeling unit 15c provides the designated label “non-Kanagawa case” to the logs of the log data 14a corresponding to the designated range. Then, the flow update unit 15d updates the flow so that the logs provided with the designated label “non-Kanagawa case” are displayed as a single log, as illustrated in FIG. 9B(e).

Furthermore, also in this case, when a user designates a label, the flow update unit 15d can update the flow so that a plurality of logs that have been provided with the designated label and displayed as a single log, can be displayed separately again. FIG. 9B(f) illustrates an example where the user has designated the label “non-Kanagawa case” in FIG. 9B(e).

Furthermore, FIG. 9C(g) illustrates an example where the user has designated a range on the flow and set a label to be provided. FIG. 9C(g) illustrates an example where the label “special order confirmation” is set to be provided to nodes in a range indicated by the bold line. In this case, the labeling unit 15c provides the set label “special order confirmation” to logs corresponding to the nodes in the designated range. Furthermore, as illustrated in FIG. 9C(h), the flow update unit 15d updates the flow so that logs provided with the set label “special order confirmation” are displayed as a single log.

Note that in the example illustrated in FIG. 9C(g), the user has designated two ranges and set the same label “special order confirmation”. In this case, although not elaborated in the figure, the flow update unit 15d updates the flow so that the ranges are sequentially provided with the label “special order confirmation” and displayed. Then, as illustrated in FIG. 9C(h), the flow update unit 15d updates the flow so that nodes in the two ranges provided with the same label “special order confirmation” are displayed as a single log.

Log Visualization Processing

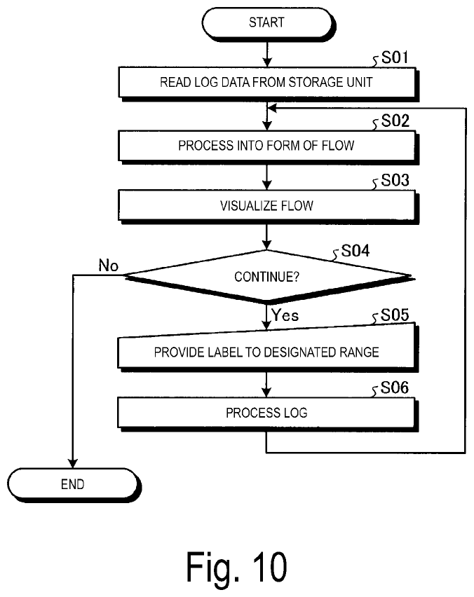

Next, log visualization processing executed by the log visualization device 10 according to the present embodiment will be described with reference to FIG. 10. FIG. 10 is a flowchart illustrating a log visualization processing procedure. The flowchart of FIG. 10 starts, for example, at a timing at which a user inputs an operation to instruct a start.

First of all, the flow generation unit 15b reads the log data 14a in the storage unit 14 (step S01), and processes the log data 14a into a form of a flow with pieces of the log data 14a arranged in a processing order (step S02), and visualizes the flow to be displayed on the output unit 12 (step S03).

When the user performs an input to designate a range on the flow and set the label to be provided (step S04, Yes), the labeling unit 15c identifies the log data within the range set by the user, and provides the label designated by the user, to the identified log data (step S05).

When the same label is given to a plurality of pieces of log data, the flow update unit 15d processes the log data into a form of a flow to display the plurality of pieces of log data as a single piece of log data (step S06 returns to S02), and visualizes the flow to be displayed on the output unit 12 (step S03).

The control unit 15 repeats the above processing and terminates the series of log visualization processing, in response to an operation input by the user for instructing the termination (step S04, No) for example.

As described above, in the log visualization device 10 according to the present embodiment, the log data 14a of the storage unit 14 stores a plurality of pieces of log data. The flow generation unit 15b generates a flow in which the pieces of log data are arranged in a processing order. The labeling unit 15c provides the label, set by the user, to pieces of log data in a range set by the user in the flow. When the same label is provided to a plurality of pieces of log data, the flow update unit 15d updates the flow to display the plurality of pieces of log data as a single piece of log data.

With the log visualization device 10 of this configuration, system logs and operational logs can be visualized as a business process flow with a granularity desired by the user, without the need to execute in advance, log adjustment processing based on user's experience and intuition Furthermore, when the analysis perspective changes, a business process flow with a different granularity of a business process can be easily visualized. Furthermore, the processing for visualizing the business process flow can be easily repeated until the granularity desired by the user is achieved.

Thus, with the log visualization device 10, system logs and operational logs can be easily visualized as a business process flow with a granularity desired by the user. Therefore, a user who is a business process analyst can easily recognize the actual condition of a business process with the appropriate granularity suitable for analytics purposes to find problems, and improve the business process according to what was found.

In a case where the label is further set by the user, the flow update unit 15d can update the flow to display a plurality of pieces of log data that have been displayed as a single piece of log data with the label provided in the updated flow, as a plurality of separate pieces of log data. This enables the user to easily confirm the flow with the granularity of the business process easily changed. Thus, the user can more easily repeat the logging and visualization of the flow interactively and seamlessly.

When the same label is provided to pieces of log data in a plurality of designated ranges, the flow update unit 15d may update the flow so that the pieces of log data in a plurality of designated ranges are displayed as a flow branched for each of the ranges. This enables the user to more easily check the business process flow with the granularity of the business process changed.

Program

It is also possible to create a program in which processing executed by the log visualization device 10 according to the embodiment described above is described in a computer-executable language. As an embodiment, the log visualization device 10 can be implemented by a log visualization program executing the log visualization processing being installed as packaged software or online software in a desired computer. For example, an information processing apparatus executes the log visualization program, and thus, the information processing apparatus can function as the log visualization device 10. The information processing apparatus referred here includes a desktop or notebook-type personal computer. Furthermore, on top of that, a mobile communication terminal such as a smart phone, a mobile phone, or a personal handyphone system (PHS), or a slate terminal such as a personal digital assistant (PDA), for example, is included in the category of the information processing apparatus. In addition, the functions of the log visualization device 10 may be implemented by a cloud server.

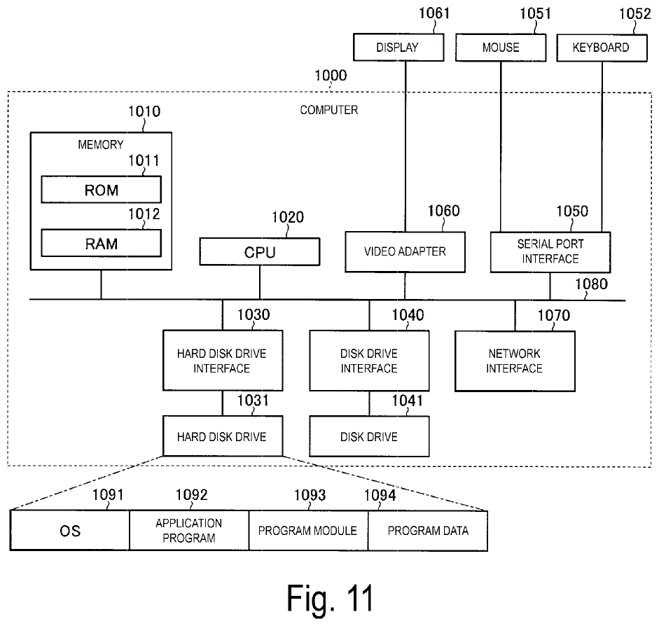

FIG. 11 is a diagram illustrating an example of the computer that executes the log visualization program. A computer 1000 includes, for example, a memory 1010, a CPU 1020, a hard disk drive interface 1030, a disk drive interface 1040, a serial port interface 1050, a video adapter 1060, and a network interface 1070. These units are connected by a bus 1080.

The memory 1010 includes a read only memory (ROM) 1011 and a RAM 1012. The ROM 1011 stores, for example, a boot program such as a basic input output system (BIOS). The hard disk drive interface 1030 is connected to the hard disk drive 1031. The disk drive interface 1040 is connected to a disk drive 1041. A detachable storage medium such as a magnetic disk or an optical disc, for example, is inserted into the disk drive 1041. A mouse 1051 and a keyboard 1052, for example, are connected to the serial port interface 1050. A display 1061, for example, is connected to the video adapter 1060.

Here, the hard disk drive 1031 stores, for example, an OS 1091, an application program 1092, a program module 1093, and program data 1094. The respective pieces of information described in the aforementioned embodiment are stored in, for example, the hard disk drive 1031 and the memory 1010.

Further, the log visualization program, for example, is stored in the hard disk drive 1031 as the program module 1093 in which instructions to be executed by the computer 1000 are described. Specifically, the program module 1093 in which each processing executed by the log visualization device 10 described in the aforementioned embodiment is described is stored in the hard disk drive 1031.

Data to be used in information processing according to the log visualization program is stored as the program data 1094, for example, in the hard disk drive 1031. Then, the CPU 1020 reads the program module 1093 or the program data 1094 stored in the hard disk drive 1031 into the RAM 1012 as needed and executes each of the aforementioned procedures.

The program module 1093 or the program data 1094 related to the log visualization program is not limited to being stored in the hard disk drive 1031. For example, the program module 1093 or the program data 1094 may be stored on a detachable storage medium and read by the CPU 1020 via the disk drive 1041 or the like. Alternatively, the program module 1093 or the program data 1094 related to the log visualization program may be stored in another computer connected via a network such as a LAN or a wide area network (WAN) and read by the CPU 1020 via the network interface 1070.

Although the embodiment to which the invention made by the present inventors is applied has been described above, the present invention is not limited by the description and the drawings constituting a part of the disclosure of the present invention according to the embodiment. In other words, all of other embodiments, examples, operation technologies, and the like made by those skilled in the art based on the present embodiment fall within the scope of the present invention.

### REFERENCE SIGNS LIST

10 Log visualization device
11 Input unit
12 Output unit
13 Communication control unit
14 Storage unit
14a Log data
15 Control unit
15a Acquisition unit
15b Flow generation unit
15c Labeling unit
15d Flow update unit

1. A log visualization device comprising:
a storage unit configured to store a plurality of pieces of log data;
a flow generation unit, including one or more processors, configured to generate a flow in which the pieces of log data are arranged in a processing order;
a labeling unit, including one or more processors, configured to provide a label set by a user to log data, in the flow, within a range designated by the user; and
a flow update unit, including one or more processors, configured to update, when same label is provided to a plurality of pieces of log data, the flow to display the plurality of pieces of log data as a single piece of log data.

2. The log visualization device according to claim 1, wherein when a label is further set by the user, the flow update unit is configured to update the flow to display the plurality of pieces of log data that have been displayed as a single piece of log data with the label provided in the updated flow, as a plurality of separate pieces of log data.

3. The log visualization device according to claim 1, wherein when same label is provided to pieces of log data in a plurality of the designated ranges, the flow update unit is configured to update the flow so that the pieces of log data in the plurality of designated ranges are displayed as a flow branched for each of the ranges.

4. A log visualization method performed at a log visualization device including a storage unit configured to store a plurality of pieces of log data, the method comprising:
generating a flow in which the pieces of log data are arranged in a processing order;
providing a label set by a user to log data, in the flow, within a range designated by the user; and
updating, when same label is provided to a plurality of pieces of log data, the flow to display the plurality of pieces of log data as a single piece of log data.

5. A non-transitory computer readable medium storing a log visualization program causing a computer to execute:
generating a flow in which a plurality of pieces of log data are arranged in a processing order;
providing a label set by a user to log data, in the flow, within a range designated by the user; and
updating, when same label is provided to a plurality of pieces of log data, the flow to display the plurality of pieces of log data as a single piece of log data.

6. The log visualization method according to claim 4, further comprising:
when a label is further set by the user, updating the flow to display the plurality of pieces of log data that have been displayed as a single piece of log data with the label provided in the updated flow, as a plurality of separate pieces of log data.

7. The log visualization method according to claim 4, further comprising:
when same label is provided to pieces of log data in a plurality of the designated ranges, updating the flow so that the pieces of log data in the plurality of designated ranges are displayed as a flow branched for each of the ranges.

8. The non-transitory computer readable medium storing the log visualization program according to claim 5, wherein the visualization program causes the computer to further execute:
when a label is further set by the user, updating the flow to display the plurality of pieces of log data that have been displayed as a single piece of log data with the label provided in the updated flow, as a plurality of separate pieces of log data.

9. The non-transitory computer readable medium storing the log visualization program according to claim 5, wherein the visualization program causes the computer to further execute:
when same label is provided to pieces of log data in a plurality of the designated ranges, updating the flow so that the pieces of log data in the plurality of designated ranges are displayed as a flow branched for each of the ranges.
